(19) United States
(12) Patent Application Publication
(10) Pub. No.: US 2023/0312319 A1
(43) Pub. Date: Oct. 5, 2023

(54) ELECTRIC BOTTLE OPENER

(71) Applicant: DANPING LIU, Shenzhen City (CN)

(72) Inventor: DANPING LIU, Shenzhen City (CN)

(21) Appl. No.: 18/120,974

(22) Filed: Mar. 13, 2023

(30) Foreign Application Priority Data
Mar. 11, 2022 (CN) 202220534203.9

(51) Int. Cl. B67B 7/04

(52) U.S. Cl. CPC B67B 7/0405; B67B 2007/0488

(57) ABSTRACT

The present invention provides an electric bottle opener, comprising: a housing with a cavity therein; a humidity sensor; a temperature sensor; a battery; a display unit for displaying a humidity value, or a temperature value or a remaining power of the battery; a motor; an on-off switch for starting or stopping the motor; a control circuit board electrically connected with the humidity sensor, the temperature sensor, the display unit, the battery, the on-off switch and the motor; and a cork screw for pulling a cork of the wine bottle; wherein the humidity sensor, the temperature sensor, the display unit, the battery, the on-off switch, the motor, the control circuit board, and the cork screw are installed in the housing; the cork screw is connected with the motor and is driven by the motor.

### CROSS REFERENCE TO RELATED APPLICATIONS

The present invention is a 35 U.S.C. §119 benefit of earlier filing date; right of priority of Chinese Application No. 202220534203.9, filed on Mar. 11, 2022, the disclosure of which is incorporated by reference herein.

### BACKGROUND OF THE INVENTION

### Field of the Invention

The present invention relates to the field of electric tools, and more particularly, to an electric bottle opener.

### Description of Related Art

The best storage environment for wine is that the temperature is 7-18° C., and the humidity is 50%-80%, which make wine at a constant temperature and good humidity to taste more mellow. With the changes in people’s living standards and life philosophy, wine has entered daily family life as a fashionable drink with health care functions. People have also improved the place environment when they drink wine, and pursue the right environment to drink wine.

At present, the existing electric bottle opener does not have a device for measuring humidity. In some cases, users often need to measure the actual temperature and humidity of wine, and they need to use special temperature and humidity measurement tools, which is not convenient.

### BRIEF SUMMARY OF THE INVENTION

An object of the present invention is to provide an electric bottle opener, which aims to solve the problem of the existing electric bottle opener cannot measure humidity and temperature of the wine bottle.

The present invention provides an electric bottle opener, comprising: a housing with a cavity therein; a humidity sensor for detecting humidity in or out of a wine bottle; a temperature sensor for detecting a temperature in or out of the wine bottle; a battery; a display unit for displaying a humidity value, or a temperature value or a remaining power of the battery; a motor; an on-off switch for starting or stopping the motor; a control circuit board electrically connected with the humidity sensor, the temperature sensor, the display unit, the battery, the on-off switch and the motor; and a cork screw for pulling a cork of the wine bottle; wherein the humidity sensor, the temperature sensor, the display unit, the battery, the on-off switch, the motor, the control circuit board, and the cork screw are installed in the housing; the cork screw is connected with the motor and is driven by the motor.

In some embodiments, the electronic bottle opener comprises a speed reducer coupled to the motor, and the cork screw is connected with the speed reducer.

In some embodiments, a power detection module for detecting the remaining power of the battery is set on and electrically connected with the control circuit board.

In some embodiments, the housing defines a button hole, a button is installed in a button hole of the housing and is electrically connected with the control circuit board; the housing forms a window, the display unit is located behind the window.

In some embodiments, the housing comprises a main shell, a base and a top cover, which are assembled to form the housing in shape of a hollow cylinder; the main shell and the base are shaped as hollow cylinders; a transparent cover is installed in the window; the cork screw extends in the base along a length thereof; a tightening ring is provided around a connection between the main shell and the base; and a tightening ring is provided around a connection between main shell and the top cover.

In some embodiments, a bottom end of the main shell connected with a top end of the base by means of tightly fitting, or a snap connection or a fastener connection; the top cover is fixed on a top end of the main shell with guiding and limiting structures provided therebetween; the main shell defines the button hole and the window for display unit, and includes an inner shell and an outer shell sleeved on the inner shell; the button with a tightening ring is installed in the button hole and tightly fixes the inner shell and outer shell together; and the transparent cover with a tightening ring is installed the window and tightly fixes the inner shell and outer shell together.

In some embodiments, the inner shell is made from plastic, and the outer shell is made of metal; both the inner and outer shells are in shape of a hollow cylinder.

In some embodiments, the base has an inner tube therein; the inner tube is used for receiving the cork screw and a cork to be removed from the wine bottle; the base and the inner tube are made from transparent materials so as to observe a progress of the cork screw drilling into the cork and pulling out the cork.

In some embodiments, the inner tube is tightly fixed in the base, and is furthered fixed by a tightening ring; the inner tube and the base are fixed by snap connection; and the cork screw extends in the inner tube along a length thereof.

In some embodiments, the housing defines one or more air holes communicating the cavity in the housing with the outer environment of the electric bottle opener; the air holes are used for outer air entering the cavity of the housing for detecting a humidity of the outer environment.

In some embodiments, the on-off switch is fixed on an inner wall of the main shell and is located above a top end of the base; the on-off switch is often close, the motor is electrically connected, and will start by touching a button on the housing, the cork screw is driven by the motor to pull the cork; when the cork is removed from wine bottle, the on-off switch is open, and the motor is electrically disconnected; the on-off switch is a mechanical switch or an electronic switch.

In some embodiments, the on-off switch is a mechanical switch with two contacts; a movable annular cap is installed on an open top end of the base and is located below the contacts of on-off switch, and is used to open and disconnect the on-off switch by means that the cork removed from the wine bottle rises in the base and pushes the movable annular cap upwards to push the contacts apart.

In some embodiments, a power interface is electrically connected with the control circuit board for connecting an external power supply; and the power interface extends from a hole of the housing.

A non-transitory computer-readable storage medium set on a control circuit board of an electric bottle opener configured to store one or more computer programs including instructions that, when executed by one or more processors set on the control circuit board, cause the one or more processors to perform steps of:
starting a motor of the electric bottle opener and driving a cork screw to rotate and pull a cork of a wine bottle;
stopping the motor when the cork is pulled out of the wine bottle; and
starting a display unit to display a humidity in the wine bottle obtained by a humidity sensor of the electric bottle opener, and/or, display a temperature in the wine bottle obtained a temperature sensor, and/or display a remaining power obtained by a power detection module.

In some embodiments, the step of “starting a display unit to display a humidity in the wine bottle obtained by a humidity sensor of the electric bottle opener, and/or, display a temperature in the wine bottle obtained a temperature sensor, and/or display a remaining power obtained by a power detection module” specifically is:
lighting up a percent sign “%” on a screen of the display unit, and displaying a humidity value obtained by the humidity sensor on a sign “888” on the screen;
after a few seconds or a preset period, turning off the percent sign “%” on the screen of the display unit, lighting up a temperature symbol “°C” on the screen, and displaying a temperature value obtained by the temperature sensor on the sign “888” on the screen; and
after a few seconds or a preset period, turning off temperature symbol “°C” on the screen, and displaying the remaining power obtained by the power detection module on the sign “888” on the screen.

In the present invention, the electric bottle opener has a temperature sensor, a humidity sensor, and a display unit in the housing, which can obtain and display the temperature and humidity in and out of the wine bottle when uncork. The electric bottle opener has a simple structure, and is very convenient for use.

### BRIEF DESCRIPTION OF THE DRAWINGS

FIGS. 1-3 is exploded views of an electric bottle opener in accordance with an embodiment of the present invention;

FIG. 4 is a cross-sectional view of the electric bottle opener in accordance with the embodiment of the present invention;

FIG. 5 illustrates an inner structure of the electric bottle opener in accordance with the embodiment of the present invention; and

FIG. 6 is a perspective view of the electric bottle opener in accordance with the embodiment of the present invention.

### DETAILED DESCRIPTION OF THE INVENTION

In order to make the subject, technical solutions, and advantages of the present invention clearer, the present invention will be described in further detail below with reference to the accompanying drawings and embodiments. The embodiments described herein are only used to explain the present invention, but not to limit the present invention.

The following embodiments illustrate the technical solutions.

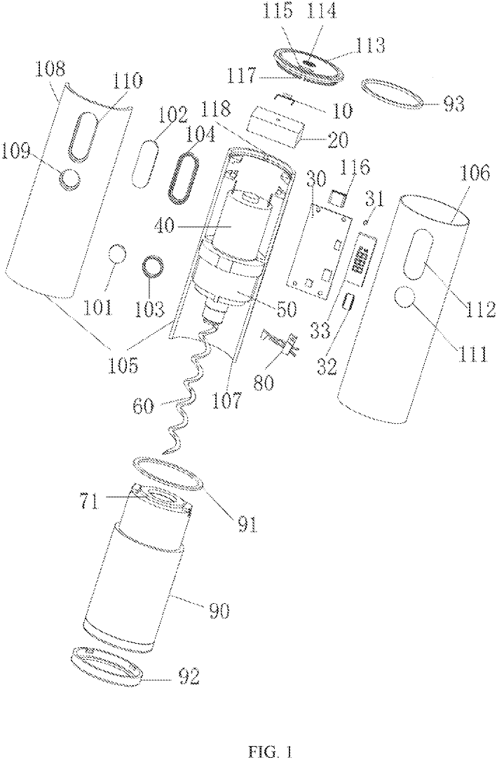

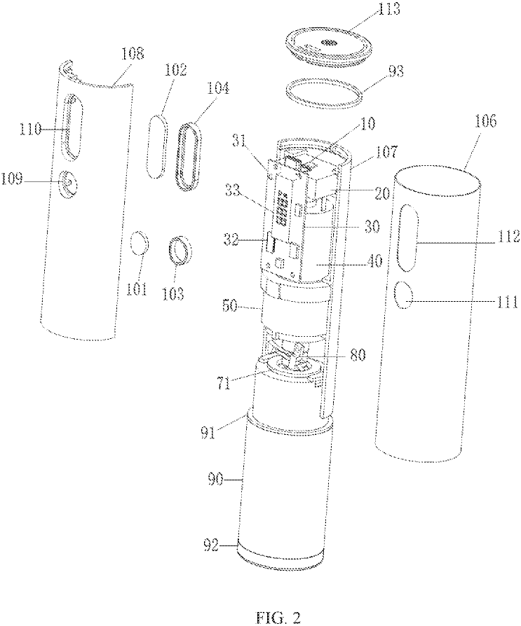

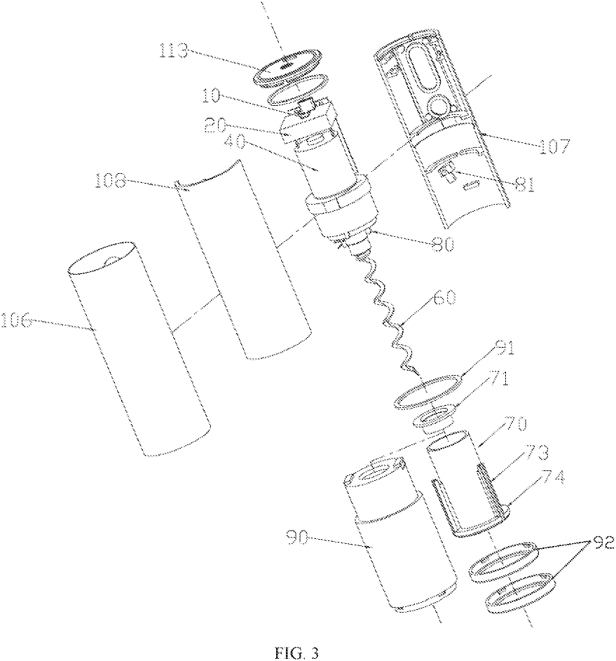

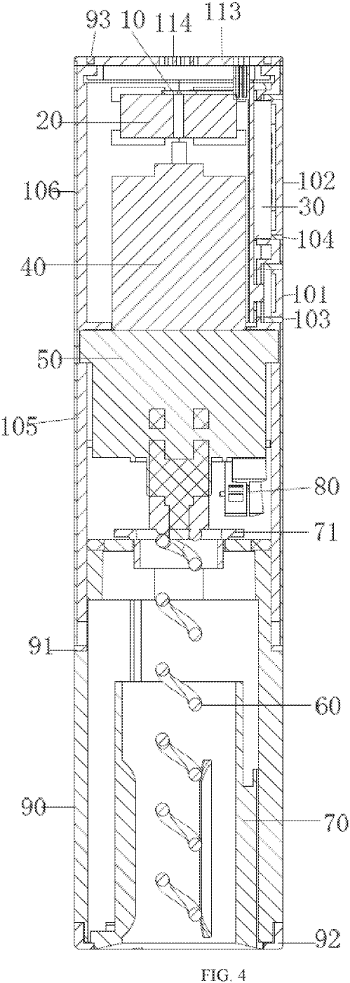

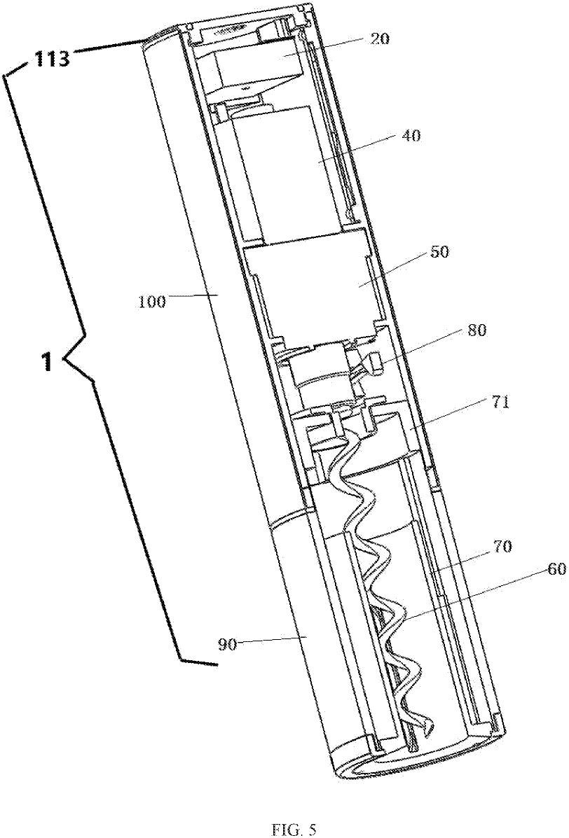

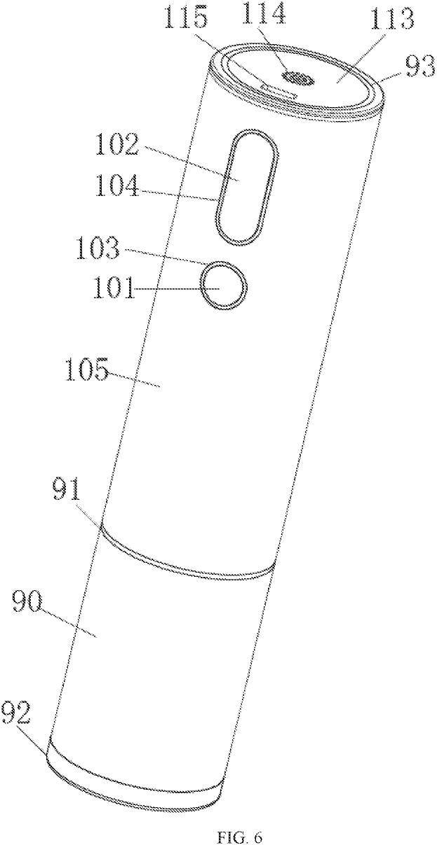

Please refer to FIGS. 1-6, an electric bottle opener provided in accordance with an embodiment of the present invention includes a housing 1, and a humidity sensor 10, a temperature sensor 31, a display unit 33, a battery 20, a control circuit board 30, a motor 40, a speed reducer 50, a cork screw 60, and an on-on switch 80 installed in (a cavity of) the housing 1. A button 101 is installed in a button hole of the housing 1 and is electrically connected with the control circuit board 30.

The housing 1 includes a main shell 100, a base 90 and a top cover 113, which are assembled to form the housing 1 in shape of a hollow cylinder with a cavity therein. The main shell 100 and the base 90 are shaped as hollow cylinders. A bottom end of the main shell 100 is connected with a top end of the base 90 for example, by means of tightly fitting, snap connection or fastener connection or others. Protrusions/holes (or grooves or gaps) are provided for connection between the top cover 113 and the main shell 100, and between the main shell and the base 90.

The top cover 113 covers on a top end of the housing 1 or the main shell 100. The base 90 provides a space for the cork screw 60. Guiding and limiting structures can be set between the top cover 113 and the top end of the main shell 100, such as a gap or gaps 117 defined in the flange of the top cover 113, and a protrusion or protrusions 118 set on the flange of the top of the main shell 100, the protrusion 118 is received in the gap 117 so as to guided and limit the top cover 113 fitting on the main shell 100 in place. The guiding and limiting structures may be an annular groove and an annular protrusion set on the top cover 113 or the main shell 100, where the annular protrusion can be received in the annular groove. The protrusions are set on the inner wall of the main shell 100, and holes are set in the base 90, the protrusion is fitted in the hole so that the main shell 100 is fixedly connected with the base 90.

In some embodiment, the main shell 100 includes an inner shell 105 and an outer shell 106 sleeved on the inner shell 105. The inner shell 105 can be made from plastic, and the outer shell 106 can be made of metal. Both the inner and outer shells 105, 106 are in shape of a hollow cylinder.

The housing 1 defines air hole(s) 114 communicating the cavity in the housing with the outer environment of the electric bottle opener, such as the air hole 114 defined in the top cover 113. The air hole 114 is set for outer air entering the cavity of the housing for detecting a humidity of the outer environment.

The housing 1 defines a button hole for installing the button 101 and a window for the display unit 33. A transparent cover 102 is installed in the window, the display unit 33 is located behind the transparent cover 102; or a screen of the display unit 33 is located in the window, so the transparent cover 102 is not necessary. In one embodiment, a hole 109 defined in the inner shell 105 and a hole 111 defined in the outer shell 106 are aligned to form the button hole, and the button 101 is connected with the control circuit board 30 and is installed in the button hole; a hole 110 defined in the inner shell 105 and a hole 112 defined in the outer shell 106 are aligned to form the window for receiving the display unit 33, and the transparent cover 102 can be installed in the window. Tightening rings 91, 92, 93, 103, 104 can be provided around the connection between main shell 100 and the base 90, around the bottom end of the base 90, around the connection between the main shell 100 and the top cover 113, in the button hole and in the window, so as to tightly fix the shells 105, 106, 90, 113, the top cover 113, the transparent cover 102, and the button 101. The button 101 with the tightening ring 103 is installed in the holes 109, 111 and tightly fixes the inner shell 105 and outer shell 106 together, and the transparent cover 102 with the tightening ring 104 is installed in the holes 110, 112 and tightly fixes the inner shell 105 and outer shell 106 together. In some embodiments, the main shell 100 is one inseparable shell in the shape of a hollow cylinder. In some embodiment, the inner shell 105 is assembled by a front part 108 and a rear part 107. Tightening rings 91, 92, 93, 103, 104 can be provided with decorative effect, for example, the tightening ring has a gold-plated layer. an inner wall of the main shell 100 (the inner shell 105) forms a mounting seat 81 for fixing the on-on switch 80.

The base 90 is in shape of a hollow cylinder, and has an inner tube 70 therein. The inner tube 70 is tightly fixed in the base 90 and is furthered fixed by the tightening ring 92. The inner tube 70 is used for receiving the cork screw 60 and a cork to be removed from a wine bottle. The inner tube 70 forms ribs 73 on an outer wall along a length of the tube 70, the rib 73 defines a groove along a length thereof, the inner wall of the base 90 forms protruding ribs for engaging with the grooves of the inner tube 70 so as to fix the inner tube 70 and the base together. A bottom end of the inner tube 70 has an annular flange 74, which is engaged with the bottom end of the case 90 and the tightening rings 92 so as to forms a snap connection therebetween, for example, the tightening rings 92, the bottom ends of both the inner tube 70 and the base 90 forms gaps or protrudins to be snapped.

In some embodiments, the inner tube 70 and the base 90 can be an unseparated structure; or, the inner tube 70 is the inner wall of the base 90. The cork screw 60 is connected with the motor 40 or the speed reducer 50, and extends in the inner tube 70 and in the base 90 along a length thereof; when the cork screw is driven to rotate by the motor 40 for uncork, the cork rises along the inner tube 70 and received in the inner tube 70. The base 90 is fixedly connected with the main shell 100 (the sleeved inner and outer shells 105, 106) in a snap fit manner and the tightening ring 91 is tightly fitted around the connection between the base 90 and the main shell 100.

Preferably, the base 90 and the inner tube 70 are made from transparent materials so as to observe the progress of the cork screw 60 drilling into the cork and pulling out the cork.

The humidity sensor 10, the temperature sensor 31, the display unit 33, the battery 20, the motor 40, the speed reducer 50, the on-on switch 80 and the button 101 are electrically connected with the control circuit board 30. The speed reducer 50 is coupled to the motor 40, and the cork screw 60 is connected with the speed reducer 50. In some embodiments, the speed reducer 50 is not necessary, and the cork screw 60 is connected with a shaft of the motor 40.

The electric bottle opener also includes an on-off switch 80, the on-off switch 80 is fixed on the inner wall of the main shell 100 and is located above a top end of the base 90. The on-off switch 80 is electrically connected with the control circuit board 30 for controlling the motor 40. The on-off switch 80 is often close, the motor is electrically connected, and will start by touching the button 101, so that the cork screw 60 is driven by the motor 40 to pull the cork; when the cork is removed from wine bottle, the on-off switch 80 is open, and the motor is electrically disconnected. The on-off switch 80 may be mechanical switch or electronic switch.

In some embodiment, the on-off switch 80 is a mechanical switch, comprises two contacts with two positions: ON position when the two contacts are connected and OFF position when the two contacts are disconnected. A movable annular cap 71 is installed on the open top end of the base 90 and below the on-off switch 80, can be engaged with contact of the on-off switch 80 when is pushed upwards by the cork removed from the wine bottle. The cork will rise upwards in the inner tube 70 or in the base 90 when the cork screw 60 is driven to pull the cork in the wine bottle; when the cork is pulled out of the wine bottle and rises to the top of the base 90, the cork will push the movable annular cap 71 upwards to push the contacts of the on-off switch 80 open and disconnect, so that the motor 40 stops.

In some embodiments, the cork can rise to push the contact of the on-off switch 80, and the movable annular cap 71 is not necessary.

The control circuit board 30 has one or more processors 32 for controlling the work of the electric bottle opener, such as control the motor 40 working or control the display unit 33 to display information. and a power interface 116 is electrically connected with the control circuit board 30 for connecting an external power supply to charge the battery 20 or directly provide power for the control circuit board 30 or the motor 40. The power interface 116 extends from a hole 115 of the housing 1.

A power detection module (not marked) for detecting the remaining power of the battery 20 is set on and electrically connected with the control circuit board 30.

The humidity sensor 10 can be used for detecting the environmental humidity, where the environment air is flow to the humidity sensor 10 through the hole(s) 114 of the housing 1, the humidity sensor 10 is located behind the air hole(s) 114. The humidity sensor 10 can be used for detecting the humidity of in the wine bottle after the cork off, and a relative humidity can be obtained according to the humidity of the outer environment and in the bottle.

The temperature sensor 31 can be used for detecting an environmental temperature out of the wine bottle, where the environment air is flow to the temperature sensor 31 through the air hole(s) 114, and also used for detecting the wine temperature in the bottle after the cork off.

The display unit 33 can display the temperature detected by the temperature sensor 31, and/or the humidity detected by the humidity sensor 10, and/or the remaining power of the battery 20 detected by the power detection module.

In one embodiment, the control circuit board 30 has non-transitory computer-readable storage medium configured to store one or more computer programs including instructions that, when executed by the one or more processors 32, cause the one or more processors to perform the steps of:
starting the motor 40 of the electric bottle opener and driving the cork screw 60 to rotate and pull the cork of the wine bottle;
stopping the motor when the cork is pulled out of the wine bottle; and
starting the display unit 30 to display the humidity obtained by the humidity sensor 10, and/or, the temperature obtained by the temperature sensor 31, and/or the remaining power obtained by the power detection module.

In one embodiment, the step of “starting the display unit 30 to display the humidity obtained by the humidity sensor 10, and/or, the temperature value obtained by the temperature sensor 31, and/or the remaining power obtained by the power detection module”, can be:
lighting up a percent sign “%” on a screen of the display unit 30, and displaying a humidity value obtained by the humidity sensor 10 on a sign “888” on the screen;
after a few seconds or a preset period, turning off the percent sign “%” on the screen of the display unit 30, lighting up a temperature symbol “°C” on the screen, and displaying a temperature value obtained by the temperature sensor 31 on the sign “888” on the screen; and
after a few seconds or a preset period, turning off temperature symbol “°C” on the screen, and displaying the remaining power obtained by the power detection module on the sign “888″on the screen.

In some embodiment, the one or more processors 32 to perform: displaying one or more information of: a temperature value, a humidity value or a remaining power value according to the needs.

The technical features of the above embodiments can be combined arbitrarily. In order to make the description simple, all possible combinations of the technical features in the above embodiments are not described. However, as long as there is no contradiction in the combination of these technical features It is considered to be the range described in this specification.

The above examples only represent several embodiments of the present invention, and the descriptions thereof are specific and detailed, but should not be construed as a limitation on the scope of the invention patent. It should be pointed out that for those of ordinary skill in the art, without departing from the concept of the present invention, several modifications and improvements can also be made, which all belong to the protection scope of the present invention. Therefore, the protection scope of the patent of the present invention should be subject to the appended claims.

What is claimed is:

1. An electronic bottle opener, comprising:
a housing with a cavity therein;
a humidity sensor for detecting humidity in or out of a wine bottle;
a temperature sensor for detecting a temperature in or out of the wine bottle;
a battery;
a display unit for displaying a humidity value, or a temperature value or a remaining power of the battery;
a motor;
an on-off switch for starting or stopping the motor;
a control circuit board electrically connected with the humidity sensor, the temperature sensor, the display unit, the battery, the on-off switch and the motor; and
a cork screw for pulling a cork of the wine bottle;
wherein the humidity sensor, the temperature sensor, the display unit, the battery, the on-off switch, the motor, the control circuit board, and the cork screw are installed in the housing;
the cork screw is connected with the motor and is driven by the motor.

2. The electronic bottle opener as claimed in claim 1, wherein the electronic bottle opener comprises a speed reducer coupled to the motor, and the cork screw is connected with the speed reducer.

3. The electronic bottle opener as claimed in claim 1, wherein a power detection module for detecting the remaining power of the battery is set on and electrically connected with the control circuit board.

4. The electronic bottle opener as claimed in claim 1, wherein the housing defines a button hole, a button is installed in a button hole of the housing and is electrically connected with the control circuit board;
the housing forms a window, the display unit is located behind the window.

5. The electronic bottle opener as claimed in claim 4, wherein the housing comprises a main shell, a base and a top cover, which are assembled to form the housing in shape of a hollow cylinder; the main shell and the base are shaped as hollow cylinders;
a transparent cover is installed in the window;
the cork screw extends in the base along a length thereof;
a tightening ring is provided around a connection between the main shell and the base; and
a tightening ring is provided around a connection between main shell and the top cover.

6. The electronic bottle opener as claimed in claim 5, wherein a bottom end of the main shell connected with a top end of the base by means of tightly fitting, or a snap connection or a fastener connection; the top cover is fixed on a top end of the main shell with guiding and limiting structures provided therebetween;
the main shell defines the button hole and the window for display unit, and includes an inner shell and an outer shell sleeved on the inner shell;
the button with a tightening ring is installed in the button hole and tightly fixes the inner shell and outer shell together; and
the transparent cover with a tightening ring is installed the window and tightly fixes the inner shell and outer shell together.

7. The electronic bottle opener as claimed in claim 6, wherein the inner shell is made from plastic, and the outer shell is made of metal; both the inner and outer shells are in shape of a hollow cylinder.

8. The electronic bottle opener as claimed in claim 5, wherein the base has an inner tube therein; the inner tube is used for receiving the cork screw and the cork removed from the wine bottle; the base is made from transparent materials so as to observe a progress of the cork screw drilling into the cork and pulling out the cork.

9. The electronic bottle opener as claimed in claim 8, wherein the inner tube is tightly fixed in the base, and is furthered fixed by a tightening ring; the inner tube and the base are fixed by snap connection; and the cork screw extends in the inner tube along a length thereof.

10. The electronic bottle opener as claimed in claim 1, wherein the housing defines one or more air holes communicating the cavity in the housing with an outer environment of the electric bottle opener; the air holes are used for outer air entering the cavity of the housing for detecting the humidity.

11. The electronic bottle opener as claimed in claim 5, wherein the on-off switch is fixed on an inner wall of the main shell and is located above a top end of the base;
the on-off switch is often close, the motor is electrically connected and will start by touching a button on the housing, whereby the cork screw is driven by the motor to pull the cork; when the cork is removed from wine bottle, the on-off switch is open, and the motor is electrically disconnected;
the on-off switch is a mechanical switch or an electronic switch.

12. The electronic bottle opener as claimed in claim 11, wherein the on-off switch is a mechanical switch with two contacts;
a movable annular cap is installed on an open top end of the base and is located below the contacts of on-off switch, and is used to open and disconnect the on-off switch by means that the cork removed from the wine bottle rises in the base and pushes the movable annular cap upwards to push the contacts apart.

13. The electronic bottle opener as claimed in claim 1, wherein a power interface is electrically connected with the control circuit board for connecting an external power supply; and the power interface extends from a hole of the housing.

14. A non-transitory computer-readable storage medium set on a control circuit board of an electric bottle opener configured to store one or more computer programs including instructions that, when executed by one or more processors set on the control circuit board, cause the one or more processors to perform steps of:
starting a motor of the electric bottle opener and driving a cork screw to rotate and pull a cork of a wine bottle;
stopping the motor when the cork is pulled out of the wine bottle; and
starting a display unit to display a humidity in the wine bottle obtained by a humidity sensor of the electric bottle opener, and/or, display a temperature in the wine bottle obtained a temperature sensor, and/or display a remaining power obtained by a power detection module.

15. The non-transitory computer-readable storage medium as claimed in claim 14, wherein the step of “starting a display unit to display a humidity in the wine bottle obtained by a humidity sensor of the electric bottle opener, and/or, display a temperature in the wine bottle obtained a temperature sensor, and/or display a remaining power obtained by a power detection module” specifically is:
lighting up a percent sign “%” on a screen of the display unit, and displaying a humidity value obtained by the humidity sensor on a sign “888” on the screen;
after a few seconds or a preset period, turning off the percent sign “%” on the screen of the display unit, lighting up a temperature symbol “°C” on the screen, and displaying a temperature value obtained by the temperature sensor on the sign “888” on the screen; and
after a few seconds or a preset period, turning off temperature symbol “°C” on the screen, and displaying the remaining power obtained by the power detection module on the sign “888” on the screen.
